(19) United States
(12) Patent Application Publication
(10) Pub. No.: US 2014/0117926 A1
(43) Pub. Date: May 1, 2014

(54) WIRELESS POWER CHARGER

(71) Applicant: CHENG UEI PRECISION INDUSTRY CO., LTD., New Taipei City (TW)

(72) Inventors: JUI-TE HWU, NEW TAIPEI CITY (TW); BO-JANG CHEN, NEW TAIPEI CITY (TW); QIN-XIANG LIU, DONG-GUAN CITY (CN)

(73) Assignee: CHENG UEI PRECISION INDUSTRY CO., LTD., NEW TAIPEI CITY (TW)

(21) Appl. No.: 13/662,468

(22) Filed: Oct. 27, 2012

(51) Int. Cl. H02J 7/00

(52) U.S. Cl. 320/108

(57) ABSTRACT

A wireless power charger includes a shell, a circuit board, a displacement adjusting device and transmitter coils disposed in the shell. The circuit board has a position detection controller for detecting a position of a charging target placed on the shell. A rack is mounted to the displacement adjusting device for only horizontally rotating along with the displacement adjusting device, or horizontally rotating along with the displacement adjusting device and further sliding linearly along a radial direction. The transmitter coils are positioned on the rack. In use, the displacement adjusting device is controlled by the position detection controller to only horizontally rotate the rack, or horizontally rotate the rack and further linearly slide the rack, so as to bring the transmitter coils closer to a receiver coil of the charging target and realize inductive coupling therebetween for charging the charging target.

### BACKGROUND OF THE INVENTION

1. Field of the Invention

The present invention relates to a power charger, and more particularly to a wireless power charger which uses inductive coupling to charge a charging target.

2. The Related Art

A wireless power charger uses electromagnetic induction to transmit electric power between a transmitter coil of the charger and a receiver coil in a charging target so as to charge a rechargeable battery of the charging target. However, the conventional wireless power charger generally includes only one transmitter coil which is often immovable in the charger. As a result, it can charge only one charging target. And it is important that the charging target must be manually placed at an appropriate position of the charger. Otherwise, the charging efficiency will be reduced or even a normal charging may not be achieved. So, a wireless power charger capable of overcoming the foregoing problems is required.

### SUMMARY OF THE INVENTION

An object of the present invention is to provide a wireless power charger which uses inductive coupling to charge at least one charging target having a receiver coil therein.

To reach such purpose, a wireless power charger with reference to a first embodiment of the present invention is described below. The wireless power charger includes a shell, a circuit board, a displacement adjusting device and a plurality of transmitter coils which are enclosed in the shell. The shell includes a pedestal and a cover covered onto the pedestal. The circuit board is fixed on the pedestal, and has a position detection controller for detecting a position of the charging target placed on the cover. The displacement adjusting device includes a turbine rotatably mounted on the pedestal, a drive motor and a rotor driven by the drive motor to bring the turbine to horizontally rotate. A rack is equipped on the turbine and horizontally rotates along with the turbine. The transmitter coils are arranged side by side on the rack.

In use, the displacement adjusting device is controlled by the position detection controller of the circuit board to horizontally rotate the rack around the turbine so as to bring the transmitter coils closer to the receiver coil of the charging target and realize inductive coupling therebetween for transmitting electric power from the transmitter coils to the receiver coil.

To reach such purpose, a wireless power charger according to a second embodiment of the present invention is described below. The wireless power charger includes a shell, a circuit board, a displacement adjusting device and at least one transmitter coil which are enclosed in the shell. The shell includes a pedestal and a cover covered onto the pedestal. The circuit board is fixed on the pedestal, and has a position detection controller for detecting a position of the charging target placed on the cover. The displacement adjusting device includes a rotary adjusting device and a stretchable adjusting device. The rotary adjusting device includes a turbine rotatably mounted on the pedestal, a first drive motor and a rotor driven by the first drive motor to bring the turbine to horizontally rotate. The stretchable adjusting device includes a base body fixed on the turbine for rotating along with the turbine, a second drive motor, a gear mounted in the base body and driven by the second drive motor to vertically rotate, and a rack levelly penetrating the base body in a sliding way and capable of horizontally rotating around the base body by the drive of the turbine and the base body. A bottom side of the rack is snapped with the gear for being further driven by the rotary gear to slide linearly along a radial direction. The transmitter coil is fixed on the rack.

In use, the displacement adjusting device is controlled by the position detection controller of the circuit board to horizontally rotate the rack around the turbine and further linearly slide the rack to bring the transmitter coil close to or away from the base body, so as to make the transmitter coil closer to the receiver coil of the charging target and realize inductive coupling therebetween for transmitting electric power from the transmitter coil to the receiver coil.

As described above, the wireless power charger of the present invention utilizes the displacement adjusting device to horizontally rotate the transmitter coils around the turbine, or horizontally rotate the transmitter coil around the turbine and further linearly slide the transmitter coil close to or away from the base body, so as to make the transmitter coils closer to the receiver coil of the charging target and realize inductive coupling therebetween for the convenience of charging the charging target.

### BRIEF DESCRIPTION OF THE DRAWINGS

The present invention will be apparent to those skilled in the art by reading the following description, with reference to the attached drawings, in which:

FIG. 1 is an exploded perspective view of a wireless power charger according to a first embodiment of the present invention; and

FIG. 2 and FIG. 3 are exploded perspective views of a wireless power charger according to a second embodiment of the present invention.

### DETAILED DESCRIPTION OF THE PREFERRED EMBODIMENT

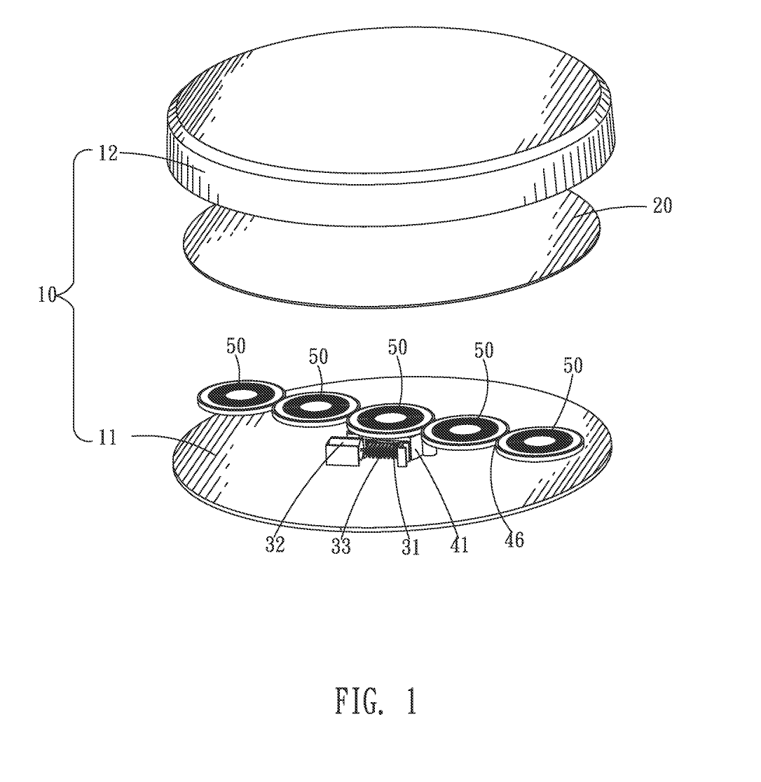

Referring to FIG. 1, a wireless power charger according to a first embodiment of the present invention uses inductive coupling to charge at least one charging target (not shown) which has a receiver coil (not shown) therein. The wireless power charger includes a shell 10, a circuit board 20, a displacement adjusting device and a plurality of transmitter coils 50 which are enclosed in the shell 10.

The shell 10 includes a pedestal 11 and a cover 12 covered onto the pedestal 11. The circuit board 20 is fixed on the pedestal 11, and has a position detection controller (not shown) for detecting a position of the charging target placed on the cover 12. The displacement adjusting device includes a turbine 31 rotatably mounted on the pedestal 11, a drive motor 32 and a rotor 33 driven by the drive motor 32 to bring the turbine 31 to horizontally rotate. A rack 46 is equipped on the turbine 31 and horizontally rotates along with the turbine 31. The transmitter coils 50 are arranged side by side on the rack 46.

In use, place the charging target on the cover 12 of the shell 10, then the position detection controller of the circuit board 20 detecting the position of the charging target on the cover 12. Then the displacement adjusting device is controlled by the position detection controller of the circuit board 20 to horizontally rotate the rack 46 around the turbine 31 so as to bring the transmitter coils 50 closer to the receiver coil of the charging target and realize inductive coupling therebetween for transmitting electric power from the transmitter coils 50 to the receiver coil. Because a plurality of transmitter coils 50 is arranged side by side on the rack 46, the wireless power charger can simultaneously charge several charging targets by placing them abreast on the cover 12.

In the first embodiment, the center of the rack 46 is vertically in the shaft of the turbine 31. One of the transmitter coils 50 is fixed at the center of the rack 46 and the others are radially arranged from the said one along the rack 46. A frame 41 is fastened on the pedestal 11 to accommodate the turbine 31 therein. The rack 46 is removably mounted on the turbine 31 by an interlocking structure.

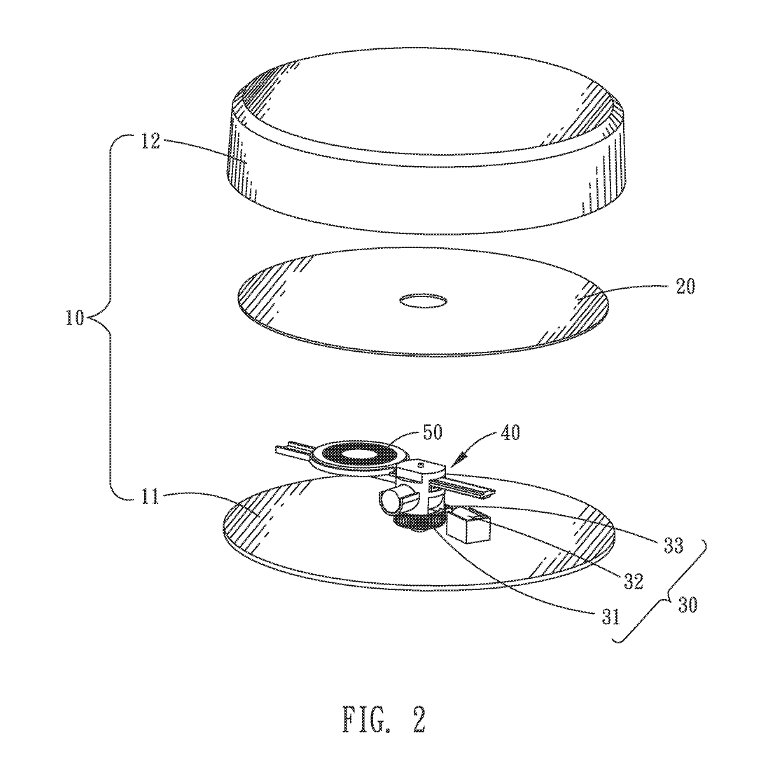

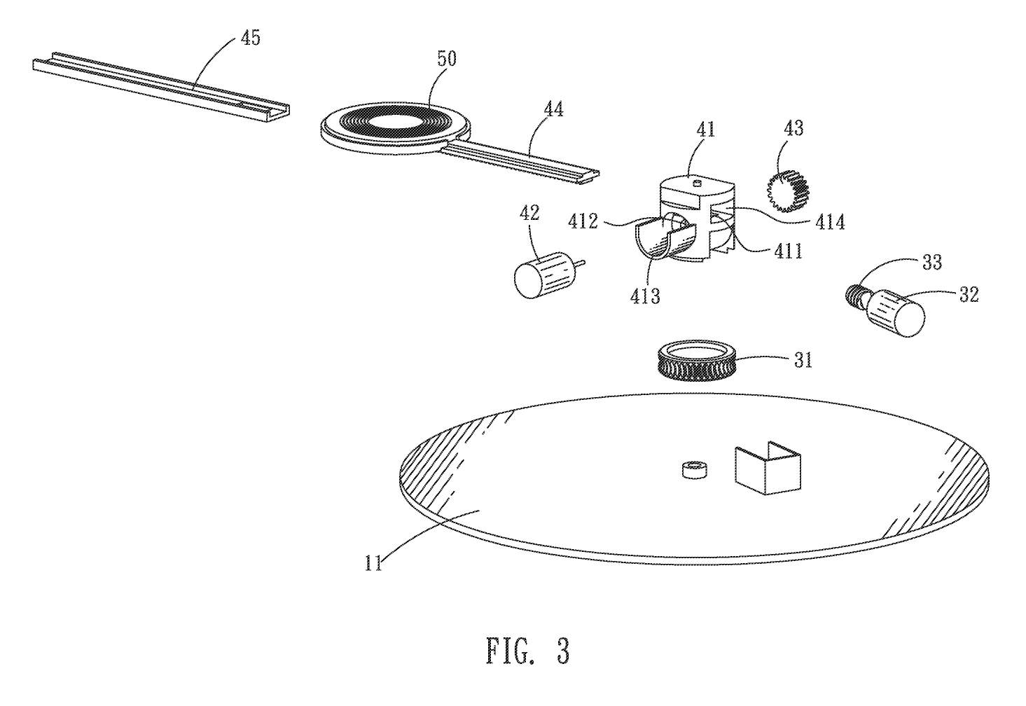

Referring to FIG. 2 and FIG. 3, they show a second embodiment of a wireless power charger of the present invention using inductive coupling to charge a charging target (not shown) which has a receiver coil (not shown) therein. The wireless power charger includes a shell 10, a circuit board 20, a displacement adjusting device and at least one transmitter coil 50 which are enclosed in the shell 10.

The shell 10 includes a pedestal 11 and a cover 12 covered onto the pedestal 11. The circuit board 20 is fixed on the pedestal 11, and has a position detection controller (not shown) for detecting a position of the charging target placed on the cover 12. The displacement adjusting device includes a rotary adjusting device 30 and a stretchable adjusting device 40. The rotary adjusting device 30 includes a turbine 31 rotatably mounted on the pedestal 11, a first drive motor 32 and a rotor 33 driven by the first drive motor 32 to bring the turbine 31 to horizontally rotate. The stretchable adjusting device 40 includes a base body 41 fixed on the turbine 31 for rotating along with the turbine 31, a second drive motor 42, a gear 43 mounted in the base body 41 and driven by the second drive motor 42 to vertically rotate, and a rack 44 levelly penetrating the base body 41 in a sliding way and capable of horizontally rotating around the base body 41 by the drive of the turbine 31 and the base body 41. A bottom side of the rack 44 is snapped with the gear 43 for being further driven by the rotary gear 43 to slide linearly along a radial direction. The transmitter coil 50 is fixed on the rack 44.

In use, place the charging target on the cover 12 of the shell 10, then the position detection controller of the circuit board 20 detecting the position of the charging target on the cover 12. Then the displacement adjusting device is controlled by the position detection controller of the circuit board 20 to horizontally rotate the rack 44 around the turbine 31 and further linearly slide the rack 44 to bring the transmitter coil 50 close to or away from the base body 41, so as to make the transmitter coil 50 closer to the receiver coil of the charging target and realize inductive coupling therebetween for transmitting electric power from the transmitter coil 50 to the receiver coil.

In the second embodiment, the inside of the base body 41 defines a lying columnar accommodating space 411 for receiving the gear 43 therein. A sidewall of the base body 41 defines an opening 412 communicated with the accommodating space 411. A bracket 413 is protruded outward near to the opening 412 for positioning the second drive motor 42 therein. The second drive motor 42 is connected with the gear 43 through the opening 412. A passageway 414 levelly penetrates through the base body 41 and is opened over and communicated with a top of the accommodating space 411 for slidably equipping the rack 44 therethrough. The stretchable adjusting device 40 further includes a guide tray 45 fastened to the passageway 414 of the base body 41 for guiding the rack 44 to slide through the passageway 414.

As described above, the wireless power charger of the present invention utilizes the displacement adjusting device to horizontally rotate the transmitter coils 50 around the turbine 31, or horizontally rotate the transmitter coil 50 around the turbine 31 and further linearly slide the transmitter coil 50 close to or away from the base body 41, so as to make the transmitter coils 50 closer to the receiver coil of the charging target and realize inductive coupling therebetween for the convenience of charging the charging target.

What is claimed is:

1. A wireless power charger using inductive coupling to charge at least one charging target which has a receiver coil therein, comprising:
a shell including a pedestal and a cover covered onto the pedestal;
a circuit board disposed in the shell and fixed on the pedestal, the circuit board having a position detection controller for detecting a position of the charging target placed on the cover;
a displacement adjusting device disposed in the shell and including a turbine rotatably mounted on the pedestal, a drive motor and a rotor driven by the drive motor to bring the turbine to horizontally rotate, a rack being equipped on the turbine and horizontally rotating along with the turbine; and
a plurality of transmitter coils arranged side by side on the rack;
wherein the displacement adjusting device is controlled by the position detection controller of the circuit board to horizontally rotate the rack around the turbine so as to bring the transmitter coils closer to the receiver coil of the charging target and realize inductive coupling therebetween for transmitting electric power from the transmitter coils to the receiver coil.

2. The wireless power charger as claimed in claim 1, wherein the center of the rack is vertically in the shaft of the turbine, one of the transmitter coils is fixed at the center of the rack and the others are radially arranged from the said one along the rack.

3. The wireless power charger as claimed in claim 1, wherein a frame is fastened on the pedestal to accommodate the turbine therein, the rack is removably mounted on the turbine by an interlocking structure.

4. A wireless power charger using inductive coupling to charge a charging target which has a receiver coil therein, comprising:
a shell including a pedestal and a cover covered onto the pedestal;
a circuit board disposed in the shell and fixed on the pedestal, the circuit board having a position detection controller for detecting a position of the charging target placed on the cover;
a displacement adjusting device disposed in the shell and including a rotary adjusting device and a stretchable adjusting device, the rotary adjusting device including a turbine rotatably mounted on the pedestal, a first drive motor and a rotor driven by the first drive motor to bring the turbine to horizontally rotate, the stretchable adjusting device including a base body fixed on the turbine for rotating along with the turbine, a second drive motor, a gear mounted in the base body and driven by the second drive motor to vertically rotate, and a rack levelly penetrating the base body in a sliding way and capable of horizontally rotating around the base body by the drive of the turbine and the base body, a bottom side of the rack being snapped with the gear for being further driven by the rotary gear to slide linearly along a radial direction; and
at least one transmitter coil fixed on the rack;
wherein the displacement adjusting device is controlled by the position detection controller of the circuit board to horizontally rotate the rack around the turbine and further linearly slide the rack to bring the transmitter coil close to or away from the base body, so as to make the transmitter coil closer to the receiver coil of the charging target and realize inductive coupling therebetween for transmitting electric power from the transmitter coil to the receiver coil.

5. The wireless power charger as claimed in claim 4, wherein the inside of the base body defines a lying columnar accommodating space for receiving the gear therein, a sidewall of the base body defines an opening communicated with the accommodating space, a bracket is protruded outward near to the opening for positioning the second drive motor therein, the second drive motor is connected with the gear through the opening, a passageway levelly penetrates through the base body and is opened over and communicated with a top of the accommodating space for slidably equipping the rack therethrough.

6. The wireless power charger as claimed in claim 5, wherein the stretchable adjusting device further includes a guide tray fastened to the passageway of the base body for guiding the rack to slide through the passageway.
